(19) United States
(12) Patent Application Publication
(10) Pub. No.: US 2002/0010569 A1
(43) Pub. Date: Jan. 24, 2002

(54) System and method for designing roads

(76) Inventor: Tadashi Yamamoto, Hiroshima (JP)

Correspondence Address: WENDEROTH, LIND & PONACK, L.L.P., 2033 K STREET N. W., SUITE 800, WASHINGTON, DC, 20006-1021, US

(21) Appl. No.: 09/904,849

(22) Filed: Jul. 16, 2001

(30) Foreign Application Priority Data
Jul. 19, 2000 (JP) 2000-218848

(51) Int. Cl. G06G 7/48

(52) U.S. Cl. 703/6

(57) ABSTRACT

A system for designing roads according to the present invention has terminal devices, which has a function of a client, for inputting information of design conditions and/or personal information of users, a server of designing roads, which has a function of a server, for offering a service for designing roads on the basis of the information of design conditions and the personal information, a computer network such as the internet for linking each of the terminal devices to the server, facsimile devices, which are installed on the side of clients, for receiving and outputting results from the server, and a communication line network for linking the facsimile devices to the server.

### FIELD OF THE INVENTION

This invention relates to a system and a method for designing roads which automatically execute road design by using a computer such as a personal computer, and more particularly to, a system and a method for designing roads with which plural users can execute road design by using communication networks such as the internet.

### BACKGROUND OF THE INVENTION

Computers such as personal computers are used in the field of road design nowadays. A conventional method for designing roads will be described in the following.

FIG. 1 is a flowchart showing processing of the conventional method for designing roads. First of all, a road designer set design conditions such as a landform, structures, a road planned site, the laws and regulations, the road structure ordinance (in the step 101).

Next, a horizontal alignment sketch is made in accordance with the design conditions set in the step 101 (in the step 102). In the concrete, a road centerline sketch is made by linking each one of plane elements of a road such as straight lines, clothoids and circular arcs by using a personal computer. Then, a width of the road is set by taking the road centerline as a standard. In this time, whether a distance between a side of the road and a structure, etc. satisfies a distance determined by the construction standard is checked.

Next, a vertical slope is checked in accordance with difference of elevation of the road and/or the landform and so on (in the step 103).

After that, plan design such as a fixation of a horizontal alignment of the road, a fixation of a nose, a construction of a road width, a ramp station and a standard crossing composition is executed (in the step 104).

And, a configuration of a vertical section of the road (a straight line and/or a parabola, etc.) is decided and vertical design such as an entry (input) of the landform and/or the control, an entry of a crossing position with a main road, a check of whether it is obtained a clearance at each condition in the horizontal direction, a check of the slope in the part of the nose and a decision of a vertical alignment is executed (in the step 105).

Then, a crossing landform is read out and crossing design such as a pavement, a placement of a road base and a road body, a placement of a soft shoulder, a slope finishing installation, a placement of structures such as a retaining wall and/or a pier, a placement of a side road and/or a ramp, a phase 1 planning is executed (in the step 106).

Furthermore, design of a slope finishing expansion and drainage such as a setting of a slope finishing expansion and drainage and a starting of the structures is executed (in the step 107).

Then, calculation documents such as a calculation of a quantity of cutting and banking, a calculation of a quantity of slope finishing processes, and an extended record and/or a mass curve are made (in the step 108).

Finally, each design result is displayed or output as three dimensional computer graphics by using a personal computer and so on (in the step 109) and checked (in the step 110). If there is no problem, the road design is finished. On the other hand, if there is inexpedience and/or failure, the processes from the step 102 are executed again.

The road designs by using personal computers are conventionally executed as mentioned above.

Computer networks (abbreviated to networks) which link plural computers, store and exchange each other data and programming codes, and share data and the like, are constructed nowadays.

As for systems of the networks, there are an open-type network system in which computers are linked freely if each computer has a certain communication protocol and the like, and a close-type network system in which the network is managed by a host computer and computer nodes which is out of the system are prohibited from linking by limiting such as security in linked terminals such as computers.

As for a typical open-type system mentioned above, the internet is prevailing. In the internet, TCP (Transfer Control Protocol)/ IP (Internet Protocol) are adopted as a protocol. Computers based on the protocol can be linked to the network.

In recent years, multimedia environments such as WWW (World Wide Web) have been improved against the background of the free network environments such as the internet. Especially, a variety of internet businesses for specific services by using the internet is proposed and managed.

In the conventional method for designing roads, however, there is a disadvantage in that the method for designing roads with which plural users design execute road design automatically by using computer networks such as the internet does not exist.

### SUMMARY OF THE INVENTION

Accordingly, it is an object of the invention to provide a system and a method for designing roads with which plural users can automatically execute road design by using computer networks such as the internet.

A system for designing roads according to the present invention, which executes road design by using a terminal connected to a computer network, comprises a terminal device which has a function of a client for inputting information of design conditions and/or personal information of users, a server of designing roads which has a function of a server for providing a service of designing roads on the basis of the information of design conditions and the personal information inputted by the terminal device and a computer network for linking the terminal device to the server, and the server of designing roads comprises network processing means which is connected to the computer network for receiving the information of design conditions and/or the personal information inputted by the terminal device and for receiving and sending information with the terminal device and road design processing means for executing road design in the basis of the information of design conditions and/or the personal information received by the network processing means and for generating road design maps and calculation documents.

A method for designing roads according to the present invention, which executes road design by using a computer network, comprises the steps of (A) transmitting images for offering information to a terminal device connected to the computer network, (B) receiving information of design conditions and/or personal information of users inputted by the terminal device on the images for offering information, (C) designing roads on the basis of the information of design conditions and the personal information of the users received in the step (B) and generating road design maps and calculation documents, and (D) transmitting the road design maps and the calculation documents generated in the step (C) to the terminal device.

### BRIEF DESCRIPTION OF THE DRAWINGS

The invention will be described in more detail in conjunction with the appended drawings, wherein:

FIG. 1 is a flowchart showing an example of the conventional service of designing roads;

FIG. 2 is a diagram showing an example of the system for designing roads according to the present invention;

FIG. 3 is a diagram showing an example of the server for designing roads according to the present invention;

FIG. 4A is a flowchart showing an example of the service of designing roads according to the present invention;

FIG. 4B is a flowchart showing an example of the service of designing roads according to the present invention;

FIG. 5A is a diagram showing a function of a dynamic clothoid interface;

FIG. 5B is a diagram showing a function of a dynamic clothoid interface;

FIG. 6A is a diagram showing a change in a slope finishing during a movement of a road centerline;

FIG. 6B is a diagram showing a change in a slope finishing during a movement of a road centerline;

FIG. 7A is a diagram showing a function of a dynamic profile interface;

FIG. 7B is a diagram showing a function of a dynamic profile interface;

FIG. 8A is a diagram showing a change in a slope finishing during a movement of a road vertical alignment;

FIG. 8B is a diagram showing a change in a slope finishing during a movement of a road vertical alignment;

FIG. 9A is a diagram showing an example of the process for making intelli-shape samples;

FIG. 9B is a diagram showing an example of the process for making intelli-shape samples;

FIG. 9C is a diagram showing an example of the process for making intelli-shape samples;

FIG. 10 is a diagram showing a function of designing an intelli-shape;

FIG. 11 is a diagram showing a method for determining a dimension of an intelli-shape figure on a road construction drawing;

FIG. 12A is a diagram showing a function of wobble by road design map generating unit 12a;

FIG. 12B is a diagram showing a function of wobble by road design map generating unit 12a;

FIG. 13A is a diagram showing the process of calculating cutting and banking planes;

FIG. 13B is a diagram showing the process of calculating cutting and banking planes;

FIG. 14A is a diagram showing the process of calculating cutting and banking planes;

FIG. 14B is a diagram showing the process of calculating cutting and banking planes;

FIG. 15A is a diagram showing the process of calculating cutting and banking planes;

FIG. 15B is a diagram showing the process of calculating cutting and banking planes; and

FIG. 16A is a diagram showing the process of calculating cutting and banking planes; and

FIG. 16B is a diagram showing the process of calculating cutting and banking planes.

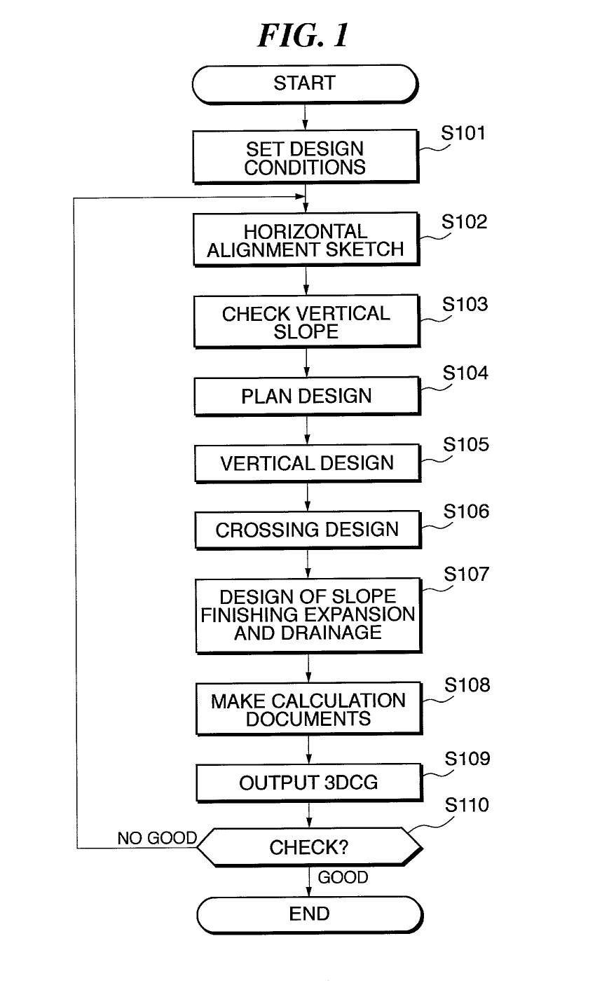

### DETAILED DESCRIPTION OF THE PREFERRED EMBODIMENTS

Referring to accompanying drawings, embodiments of a system and a method for designing roads according to the present invention will be explained as follows. In the system and the method for designing roads of the present invention, a service of designing roads with which users can automatically execute road design on the basis of information inputted by the users by using communication networks such as the internet.

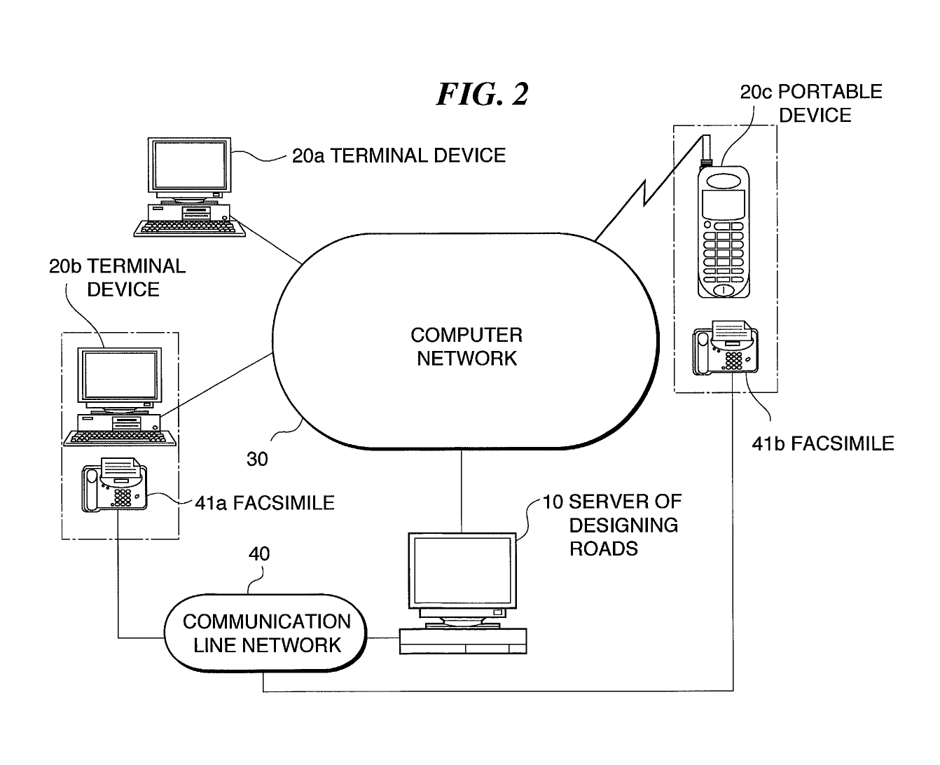

FIG. 2 is a diagram showing a system for designing roads according to an embodiment of the present invention. The system of designing roads comprises terminal devices 20a, 20b such as personal computers, which has a function of a client, for inputting information of design conditions and/or personal information of users, portable terminal 20c such as a portable telephone, which has a function of a client, for inputting information of design conditions and/or personal information of users, server of designing roads (abbreviated to a server) 10, which has a function of a server, for providing a service of designing roads on the basis of the information of design conditions and the personal information, computer network (abbreviated to a network) 30 such as the internet for linking each of terminals (abbreviated to clients) 20a-20c to server 10, facsimile devices 41a, 41b, which are installed on the side of clients, for receiving and outputting results from server 10, and communication line network 40 for linking facsimile devices 41a, 41b to server 10.

In this embodiment, network 30 can be constructed by using the internet and intranet. Therefore, the system of designing roads can be constructed at low cost because existent applications and systems on the basis of internet protocol can be applied.

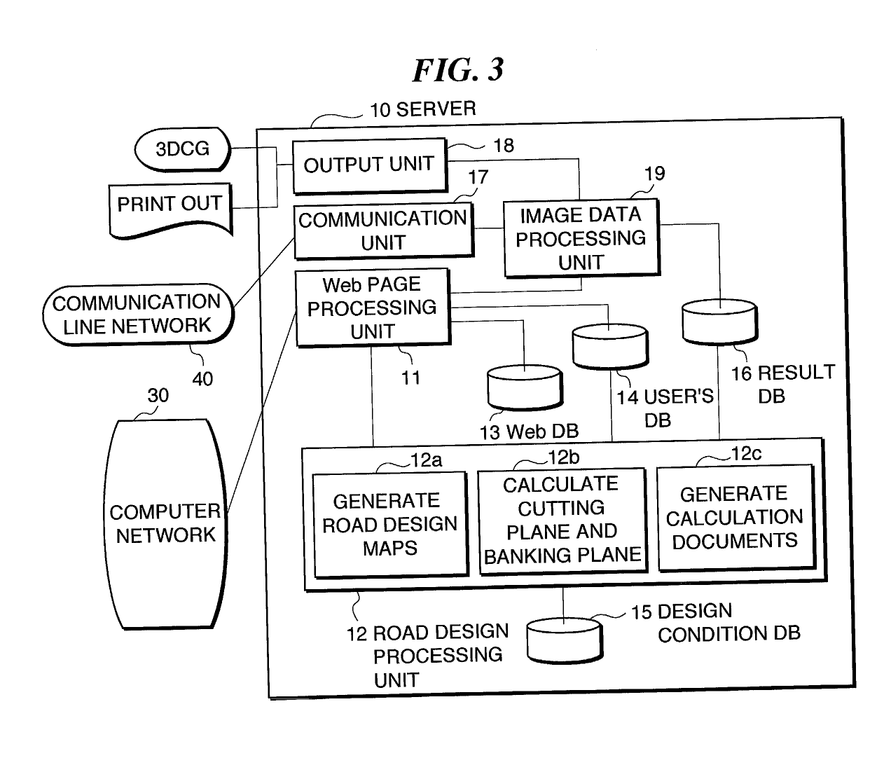

FIG. 3 is a diagram showing an example of a constitution of server 10 as shown in FIG. 2. In FIG. 3, server 10 comprises Web DB (Web Data Base) 13 for storing Web pages and network applications, which are employed as screen images for inputting the information of design conditions, Web page processing unit 11, which is connected to network 30 such as the internet, for sending the Web pages stored in Web DB 13 to terminal devices 20a˜20c (FIG. 2) connected to computer network 30 and receiving the information of design conditions and the personal information of the users inputted by terminal devices 20a˜20c (FIG. 2), user's DB 14 for storing the information of the users received in Web page processing unit 11, design condition DB 15 for storing data such as the information of design conditions received in Web page processing unit 11, road design processing unit 12 for executing road design on the basis of the design processing commands received in Web page processing unit 11 and/or the information of design conditions stored in design condition DB 15, result DB 16 for storing road design maps and/or calculation documents made by road design processing unit 12, image data processing unit 19 for converting formats to provide data files with a certain format on such as the road design maps and/or the calculation documents stored in result DB 16, output unit 18 such as a display and/or a printer for outputting the road design maps and the calculation documents converted by image data processing unit 19 on three dimensional computer graphics and/or printer sheets, and communication unit 17, which links to network 30 such as the internet, for sending the data files on the road design maps and the calculation documents converted into certain format by image data processing unit 19 to terminal devices 20a˜20c (FIG. 2) connected to computer network 30.

In this embodiment, road design processing unit 12 comprises road design map generating unit 12a for generating a road design maps on the basis of the design process commands received by Web page processing unit 11 and/or the information of the design conditions stored by design condition DB 15, cutting and banking planes calculation processing unit 12b for calculating a cutting plane and a banking plane on the basis of the road design maps generated by road design map generating unit 12a, and calculation document generating unit 12c for generating calculation documents on a mass calculation and/or a quantity of slope finishing processes on the basis of the road design maps generated by road design map generating unit 12a and the cutting plane and/or the banking plane calculated by cutting and banking planes calculation processing unit 12b.

Next, a service of designing roads which uses the system for designing roads of the present invention shown in FIG. 2 and FIG. 3 will be explained. In the following, for example, terminal device 20ais a personal computer which has a function of a client and computer network 30 is the internet. The service is offered to constructors such as consultants of civil engineering, construction companies, the Ministry of Construction, public corporations and local governments.

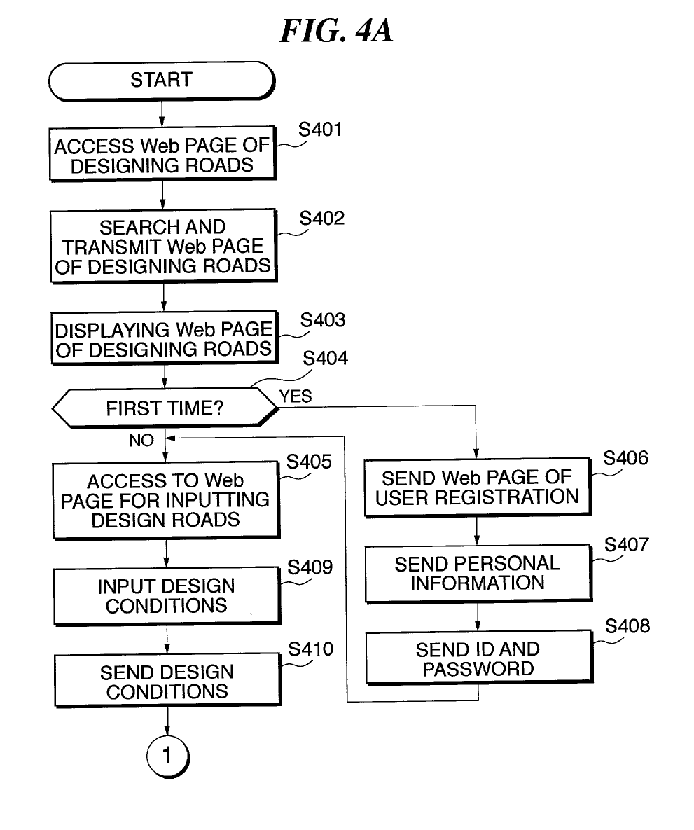

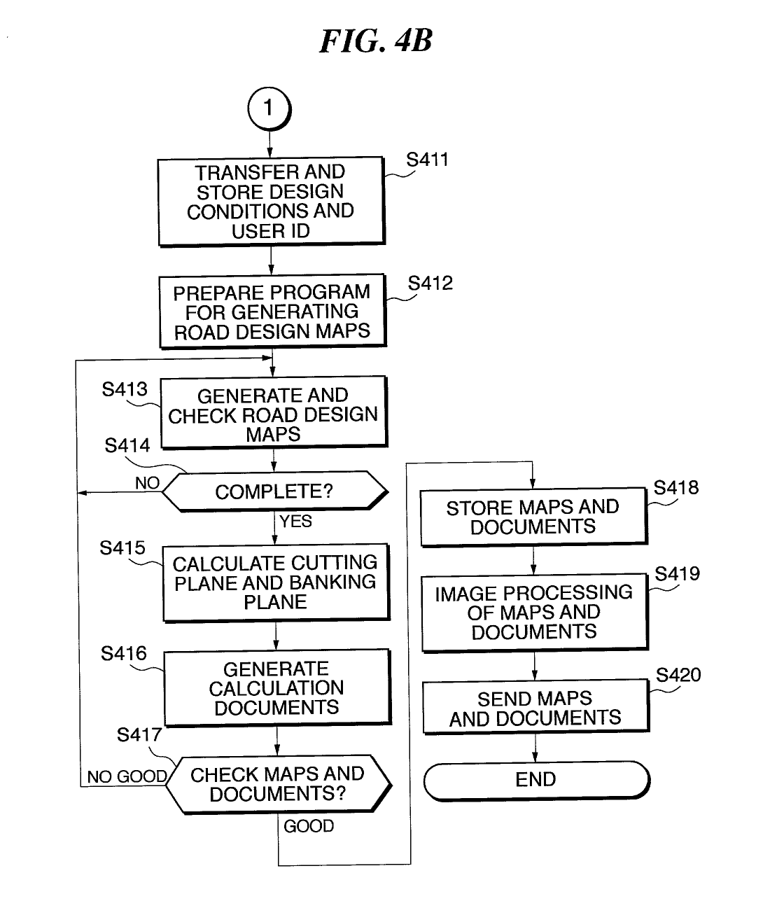

FIG. 4A and FIG. 4B are flowcharts showing the service of designing roads which uses the system for designing roads of the present invention. In FIG. 2˜FIG. 4B, a user such as consultants of civil engineering, construction companies, the Ministry of Construction, public corporations and local governments starts up a browser on terminal device (abbreviated to PC) 20a of the user side and accesses a Web page offered by Web page processing unit 11 in server 10 via computer network (abbreviated to network) 30 (in the step 401). Web page processing unit 11 searches a Web page of a screen image of designing roads from Web pages stored in Web DB 13 according to an access request (URL) from PC 20a and transmits this Web page to PC 20a (in the step 402). Then, a Web page of an application of designing roads is displayed on the screen of PC 20a (in the step 403).

Next, the user inputs an ID and a password which discriminate and identify the user and accesses to a Web page for inputting design conditions (in the steps 404, 405). At this time, when the service offer is the first time (in the step 404) and the ID and the password are not registered, a Web page of user registration is sent to PC 20a (in the step 406).

When the Web page of user registration is displayed on PC 20a, necessary personal information is filled into each item in a Web page for inputting information and the personal information is sent to Web page processing unit 11 in server 10 via network 30 (in the step 407). As the necessary personal information filled into each item in the Web page of user registration, a user name, an address, a mail address, a receiving format of output results and a way of settlement and the like are included.

Web page processing unit 11 determines an ID and a password in accordance with the personal information received from PC 20a and sends the ID and the password to PC 20a of the user side (in the step 408). In this manner, the user access the Web page for inputting design conditions by inputting the ID and the password sent from server 10(in the step 405).

Next, the user executes the process for designing roads by inputting desired design conditions using Web pages displayed on PC 20a (in the step 409). The design conditions which the user inputs in PC 20a are sent to Web page processing unit 11 in server 10 via network 30 (in the step 410).

Next, Web page processing unit 11 in server 10 transfers the design conditions to road design processing unit 12 with a user ID and road design processing unit 12 stores these design conditions in design condition DB 15 by relating with the user ID (in the step 411).

Next, road design map generating unit 12a in road design processing unit 12 prepares a program for generating road design maps on the basis of the design conditions and the user ID stored in design condition DB 15 and offers to the user (in the Step 412). Then, the program can be sent to the user using a Web page via Web page processing unit 11 when server 10 starts up the program and the user is in the on-line condition. Or, the user can download the program in PC 20a of the user side and execute the program directly on PC 20a.

The user generates road design maps by inputting certain commands, additional information, modification information and the like to the program for generating road design maps offered to the user from PC 20a. This process for generating the road design maps is executed automatically by the processing of a horizontal alignment sketch, the processing of checking a vertical slope, the processing of plan design, the processing of vertical design, the processing of crossing design and the processing of design of a slope finishing expansion and drainage, and the like.

In the concrete, when the processing of a horizontal alignment sketch, the processing of plan design, the processing of vertical design and the processing of crossing design are executed, road centerlines and the like can be easily designed by automatically linking straight lines, circular arcs and clothoid curves using the dynamic clothoid. And also, the freedom of design limit base (for example, height of components, etc.) can be easily estimated by using a function of wobble. Furthermore, in the processing of vertical design, vertical design is executed by using a dynamic profile. In the dynamic profile, a ramp of a new constructed road follows automatically as a vertical alignment of a new constructed main road by moving vertical curves of roads flexibly. And, in the processing of cross design, the installation of piers and a slope finishing, etc. is executed automatically by dragging and dropping prepared civil components such as piers and a slop finishing, etc. by using a function of drag and drop of an intelli-shape.

Therefore, the road design maps are generated automatically by executing the processing of a horizontal alignment sketch, the checking of a vertical slope, the processing of plan design, the processing of vertical design, the processing of crossing design and the processing of design of a slope finishing expansion and drainage and the like, by using the dynamic clothoid, the function of wobble, the dynamic profile and the function of drag and drop of an intelli-shape which are executed by the program for generating road design maps. The road design maps made by processes mentioned above are evaluated on the display of PC 20a (in the step 413).

If there is not any addition and modification, the process for calculating a cutting plane and a banking plane is executed by cutting and banking planes calculation processing unit 12b (in the step 414, the step 415).

In cutting and banking planes calculation processing unit 12b, a calculation of an end of a slope finishing of a cutting plane and/or a banking plane is executed on the basis of the road design maps generated by road design map generating unit 12a (in the step 415). This calculation is combined one of calculations (A) to (C) with one of calculations (1) to (2). The calculations (A) to (C) and (1) to (2) are:

(A) a line intersection calculation between a 3D (three dimensional) wire frame of land contour lines and a 3D wire frame of a standard crossing;

(B) a line intersection calculation between 3D/TIN (Triangular Irregular Network) (polygon) of land contour lines and a 3D wire frame of a standard crossing;

(C) a line crossing calculation between 3D/TIN (polygon) of land contour lines and a 3D patch (polygon) of a standard crossing;

(1) a line crossing calculation between land 3D/TIN (polygon) which is divided to contour lines, existent roads, rice fields, outfields, residential regions, etc. and a 3D patch (curve plane) of a standard crossing; and

(2) a line crossing calculation between land 3D/TIN (curve plane) which is divided to contour lines, existent roads, rice fields, outfields, residential regions, etc. and a 3D patch (curve plane) of a standard crossing.

Therefore, in cutting and banking planes calculation processing unit 12b, the calculation of a cutting plane and/or a banking plane is executed using one of (A) to (C) by expanding the calculation of (1) or (2). And at this time, looped curve planes of an interchange, etc. and sweep curve planes of a road section are made.

Next, in calculation document generating unit 12c, mass calculation documents and calculation documents of a quantity of slope finishing processes, etc. are made on the basis of processing results of road design map generating unit 12a and cutting and banking planes calculation processing unit 12b (in the step 416).

The mass calculation documents and the calculation documents of a quantity of slope finishing processes, etc. are evaluated on the display of PC 20a (in the step 417).

If there is not any addition and modification in the road design maps and the mass calculation documents and/or the calculation documents of a quantity of slope finishing processes, etc. (in the step 417), the road design maps and the mass calculation documents and/or the calculation documents of a quantity of slope finishing processes, etc. are stored in result DB 16 by relating with the user information such as the user ID (in the step 418)

In image data processing unit 19, the road design maps and the mass calculation documents and/or the calculation documents of a quantity of slope finishing processes, etc. stored in result DB 16 are executed image processing in accordance with the user information (in the step 419), are sent to the user side with the format desired by the user (in the step 420).

Therefore, when users request the road design maps and the mass calculation documents and/or the calculation documents of a quantity of slope finishing processes, etc. as files which can be processed on a PC, these files are sent from Web page processing unit 11 to user's PC via network 30 (or, the files are offered so as to be downloaded by a PC) . When users request via facsimile, etc., the road design maps and the mass calculation documents and/or the calculation documents of a quantity of slope finishing processes, etc. can be sent from communication unit 17 to user's facsimile devices via communication line network 40 such as a telephone. When users request printed papers of the road design maps and the mass calculation documents and/or the calculation documents of a quantity of slope finishing processes, etc., papers can be outputted using a printer of output unit 18 and sent to users by mail.

In these manners, users can make easily road design maps and mass calculation documents and/or calculation documents of a quantity of slope finishing processes, etc. and receive them by Web page or e-mail and download in HDD (Hard Disk Drive) of PC 20a, and also get easily these maps and documents via a facsimile and by mail.

Next, the processing of the step 413 and the step 415 will be concretely explained as follows. First, the process for generating road design maps in the step 413, road design map generating unit 12a has a function of a dynamic clothoid interface, which can automatically move a road centerline which is constructed with straight lines, circular arcs and clothoid curves as continuity of the road centerline is maintained on the basis of certain confined conditions by treating the road centerline as an elastic cord and moving an arbitrary point on the road centerline in an arbitrary direction using a pointer on a display.

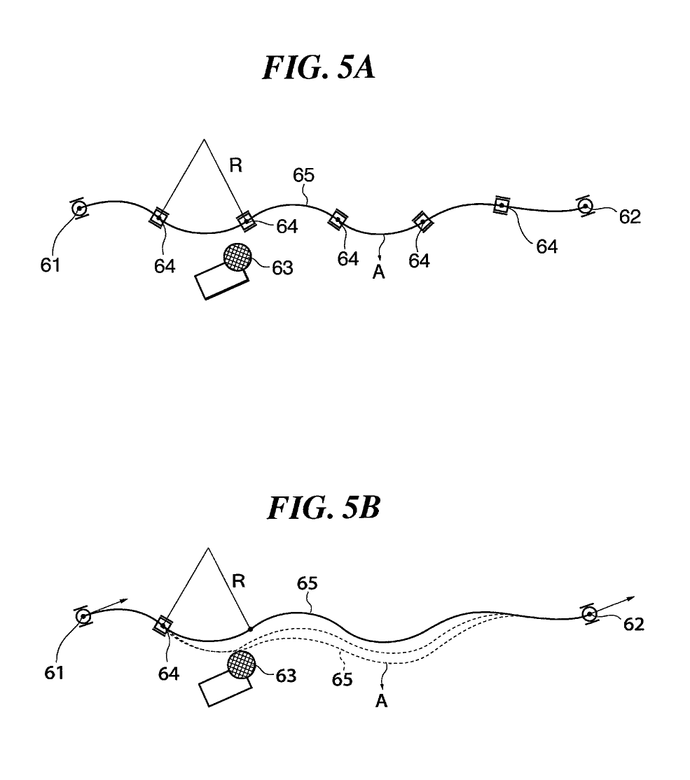

FIG. 5A and FIG. 5B are diagrams showing the function of the dynamic clothoid interface. First, origin point 61 which has a starting direction of a road and attached point 62 which has an ending direction of a road are determined as fixed points. Next, fixation confined conditions 63 such as constructions and protected districts, etc. are searched on design condition DB 15. And, concurrently, straight lines, circular arcs and clothoid curves which are determined at the time of designing roads are recognized and connecting points 64 of them are recognized. After that, dimensional confine of each of the circular arcs (radius R), the straight lines and the clothoid curves is determined. On the basis of geometrical confined conditions of origin point 61 (fixed point), attached point 62 (fixed point) and connecting points 64, fixation confined conditions 63, and the dimensional confined conditions, road center line 65 can be moved continuously (in FIG. 5A and FIG. 5B, a movement in the direction of an arrow A is shown)

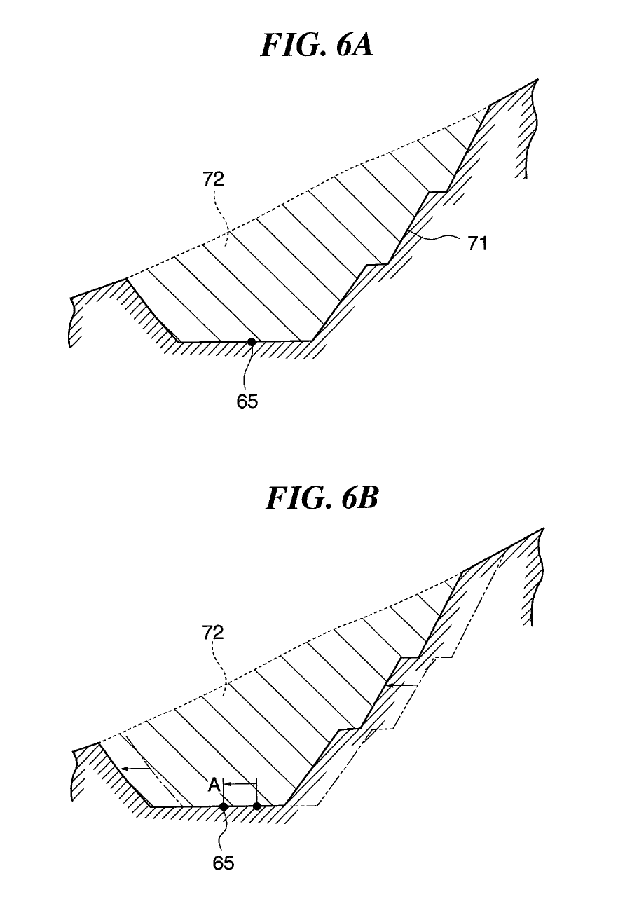

FIG. 6A and FIG. 6B are diagrams showing a change of a slope finishing during a movement of a road centerline. A change of slope finishing 71 on a road sectional plan can be calculated automatically by the movement of road centerline 65 as shown in FIG. 5A and FIG. 5B. Therefore, a change of cutting plane 72 can be calculated automatically.

By using the function of the dynamic clothoid interface of road design map generating unit 12a as mentioned above, trials of designing roads can be executed continuously without limitation and with easy operation, and the reduction of construction expenses during designing roads and shortening in design time can be attained.

And, the process for generating road design maps in the step 413, road design map generating unit 12a has a function of a dynamic profile interface which can automatically move a road vertical alignment constructed with a parabola as continuity of the road vertical alignment is maintained on the basis of certain confined conditions by treating the road vertical alignment as an elastic cord and moving an arbitrary point on the road vertical alignment in an arbitrary direction using a pointer on a display.

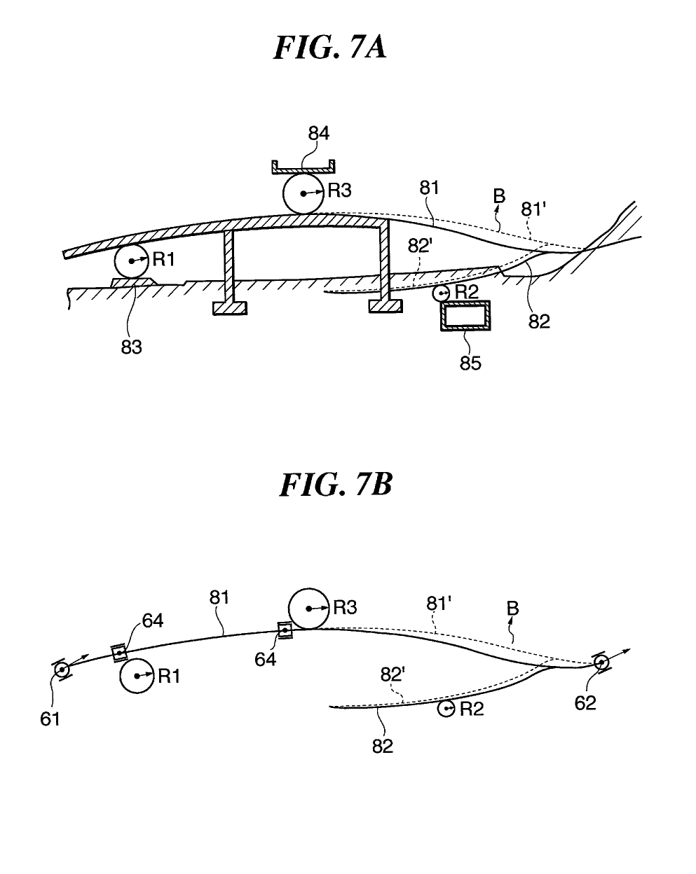

FIG. 7A and FIG. 7B are diagrams showing the function of the dynamic profile interface. First, origin point 61 which has a starting direction of a road vertical alignment (vertical alignment of a newly constructed main road) 81 and attached point 62 which has an ending direction of the road vertical alignment are determined as fixed points. Next, fixation confined conditions R1 to R3 such as existent road 83, existent bridge 84, existent underground construction 85, etc. are searched on design condition DB 15. And, concurrently, road vertical alignment 81 determined at the time of designing roads is recognized and connecting point 64 is recognized. On the basis of geometrical confined conditions of origin point 61 (fixed point), attached point 62 (fixed point) and connecting points 64, and each of fixation confined conditions R1 to R3, road vertical alignment (main road) 81 can be moved continuously (in FIG. 7A and FIG. 7B, a movement in the direction of an arrow B makes dotted line 81′ a road vertical alignment after the movement (main road)). And, when main road 81 is moved, vertical line 82 of a newly constructed road ramp is also moved automatically and newly ramp vertical line 82′ is calculated and displayed automatically.

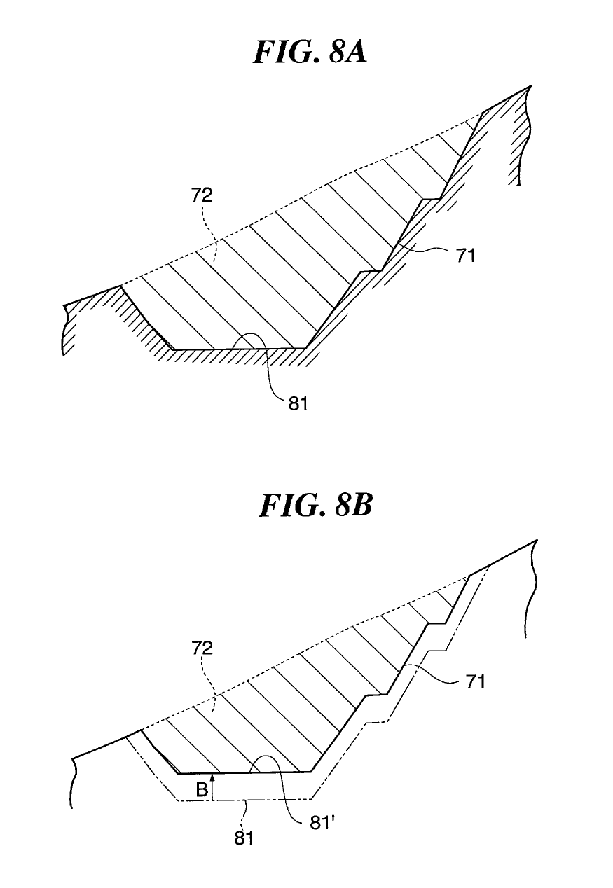

FIG. 8A and FIG. 8B are diagrams showing a change of a slope finishing during a movement of a road vertical alignment. By transferring road vertical alignment 81 to road vertical alignment 81′ as shown in FIG. 8A and FIG. 8B, a change of slope finishing 71 on a road sectional plan can be calculated automatically. Therefore, a change of cutting plane 72 can be calculated automatically.

By using the function of the dynamic profile interface of road design map generating unit 12a as mentioned above, trials of designing roads can be executed continuously without limitation and with easy operation, and the reduction of construction expenses during designing roads and shortening in design time can be attained.

And, the process for generating road design maps in the step 413, road design map generating unit 12a has a function of an intelli-shape design which can execute road construction independently by dragging and dropping prepared intelli-shape samples and links with the function of the dynamic clothoid interface and the dynamic profile interface.

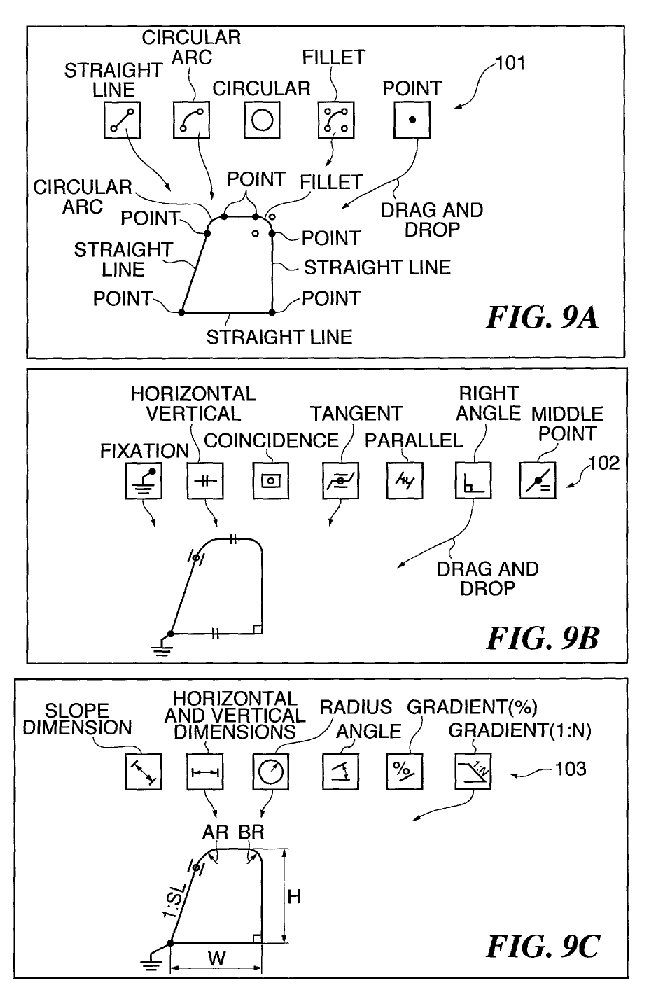

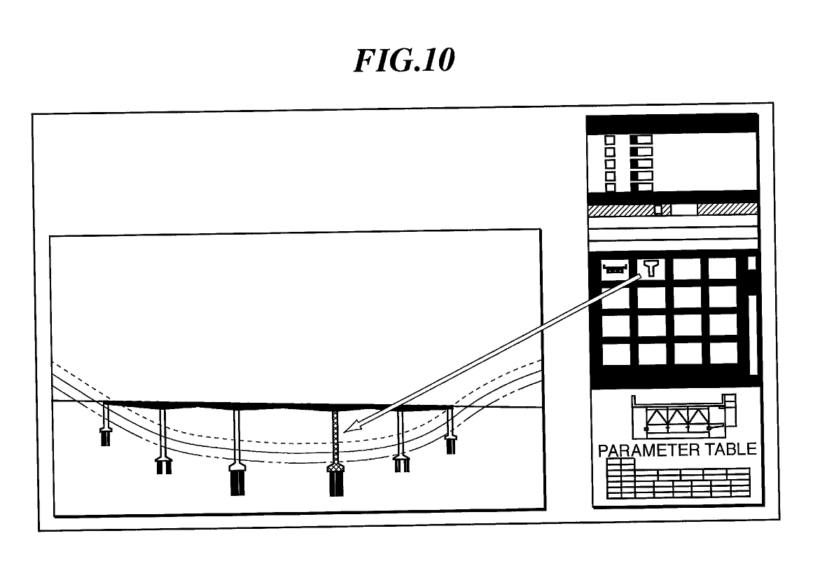

FIG. 9A, FIG. 9B and FIG. 9C are diagrams showing an example of the process for making intelli-shape samples. FIG. 10 is a diagram showing a function of designing an intelli-shape. First, by dragging and dropping certain prepared figure components 101 (straight lines, circular arcs, circles, fillets and points), an outline of a necessary parametric figure is made as shown in FIG. 9A. At this time, a configuration and an angle of each connecting point are not correct yet. Next, by adding prepared geometrical confined components 102 (fixation, horizontal and vertical, coincidence, tangent, parallel, right angle, middle point) to each of figure components 101, constraint among figure components is gained as shown in FIG. 9B. Therefore, the configuration and/or the angle of each connecting point are determined correctly and the connecting point is formed into a smooth shape. Next, by applying dimensional components 103 (a slope dimension, a horizontal and a vertical dimensions, a radius, an angle, a gradient [%], a gradient [1:N]) to each of figure components, necessary parametric figures are made as shown in FIG. 9C. These parametric figures are prepared as intelli-shape samples in design condition DB 15.

Next, as described in FIG. 10, on a screen image of constructing roads, first of all, a road construction drawing is made by selecting necessary intelli-shape samples (in FIG. 10, piers are selected) and dragging and dropping on the screen image. At this time, when part of the road construction drawing, for example, a road vertical alignment is changed, the dimension of the intelli-shape figure on the road construction drawing is changed automatically.

FIG. 11 is a diagram showing a method for determining a dimension of an intelli-shape figure on a road construction drawing. As described in FIG. 11, when origin point 61 (fixed point) and attached point 62 (fixed point) of pier 1201 are determined as shown in FIG. 11 and girder height KH, base embedment depth D, shoe height SH are predetermined, and when road surface height (road surface standard level) RH and ground base height (ground base standard level) GH are changed by the functions of the dynamic clothoid interface and the dynamic profile interface, a dimension is automatically calculated using the following equation (1) and the road construction drawing is automatically modified on the screen image.

H=(RH-GH)−KH−SH+D

As mentioned above, almost all of construction components can be easily registered as intelli-shape figures and a configuration of an intelli-shape can be changed without limitation, so that the function of the intelli-shape design can be linked with the function of the dynamic clothoid interface and the function of the dynamic profile interface easily, and trials of designing roads can be executed continuously without limitation and with easy operation. Therefore, the reduction of construction expenses during designing roads and shortening in design time can be attained.

Next, a function of wobble will be explained in the following.

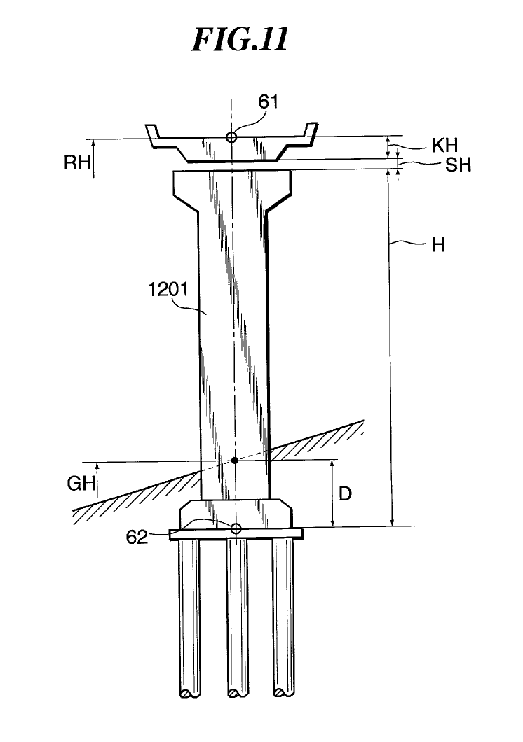

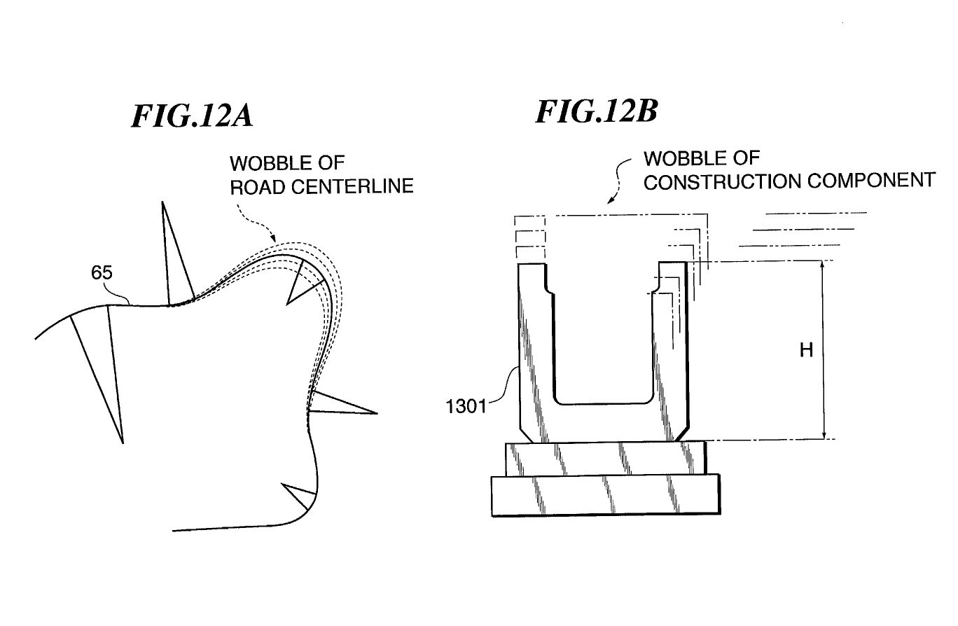

FIG. 12A and FIB. 12B are diagrams showing the function of wobble by road design map generating unit 12a. As shown in FIG. 12A and FIB. 12B, when an arbitrary place of road centerline 65 and/or intelli-shape (construction component) 1301 is clicked (indicated), maximum capable moving range in the pointed place is displayed. Therefore, design users can decide without delay whether the pointed place can be modified or not, and can decide the capable range of modification if the modification can be executed. Therefore, trials of designing roads can be executed with easy operation and the reduction of construction expenses during designing roads and shortening in design time can be attained.

Next, the process for calculating cutting and banking planes in the step 415 will be explained as follows. As mentioned above, in cutting and banking planes calculation processing unit 12b, the calculation of an end of a slope finishing of a cutting plane and/or a banking plane is executed on the basis of the road design maps generated by road design map generating unit 12b (in the step 415). The calculation is combined one of calculations (A) to (C) with one of calculations (1) to (2). The calculations (A) to (C) and (1) to (2) are:

(A) a line intersection calculation between a 3D (three dimensional) wire frame of land contour lines and a 3D wire frame of a standard crossing;

(B) a line intersection calculation between 3D/TIN (Triangular Irregular Network) (polygon) of land contour lines and a 3D wire frame of a standard crossing;

(C) a line crossing calculation between 3D/TIN (polygon) of land contour lines and a 3D patch (polygon) of a standard crossing;

(1) a line crossing calculation between land 3D/TIN (polygon) which is divided to contour lines, existent roads, rice fields, outfields, residential regions, etc. and a 3D patch (curve plane) of a standard crossing; and

(2) a line crossing calculation between land 3D/TIN (curve plane) which is divided to contour lines, existent roads, rice fields, outfields, residential regions, etc. and a 3D patch (curve plane) of a standard crossing. In the following, a method of this combined calculation will be explained.

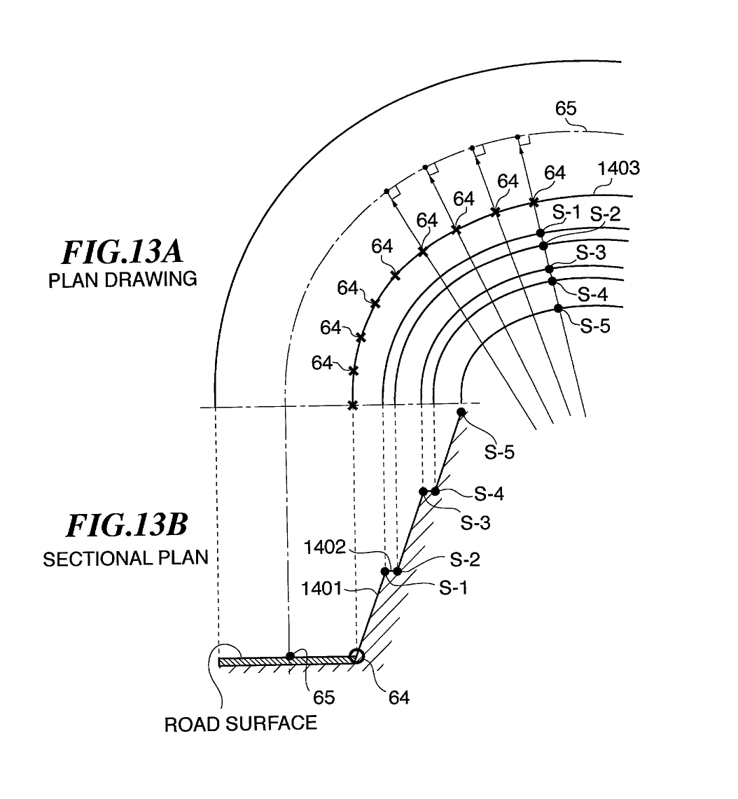

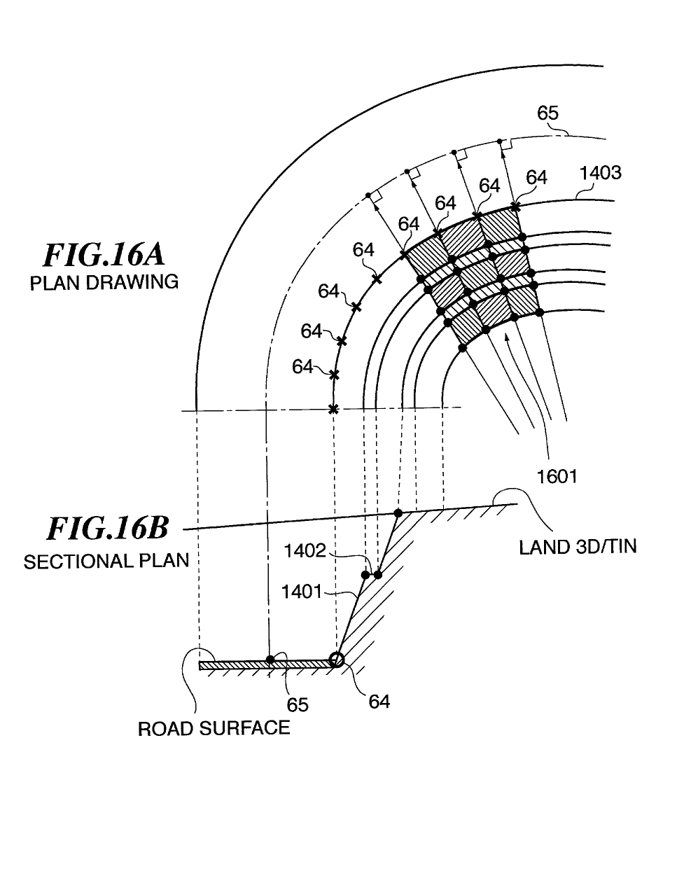

FIGS. 13A to 16B are diagrams showings the process for calculating cutting and banking planes. In this case, an offset value of a road (offset curve 1403) is approximated as a Bezier curve. And a vertical line which passes through a connecting point of Bezier curves is downed on road centerline 65. First of all, as described in FIG. 13A and FIG. 13B, a plan drawing and a sectional plan of a road are displayed on a screen of a PC correspondingly. When coordinates (x, y, z) of an arbitrary point of small step 1402 on a standard crossing slope finishing 1401 is calculated, each coordinates (x1, y1, z1) to (x5, y5, z5) of each point S1 to S5 is calculated automatically on the basis of the design conditions stored in design condition DB 15.

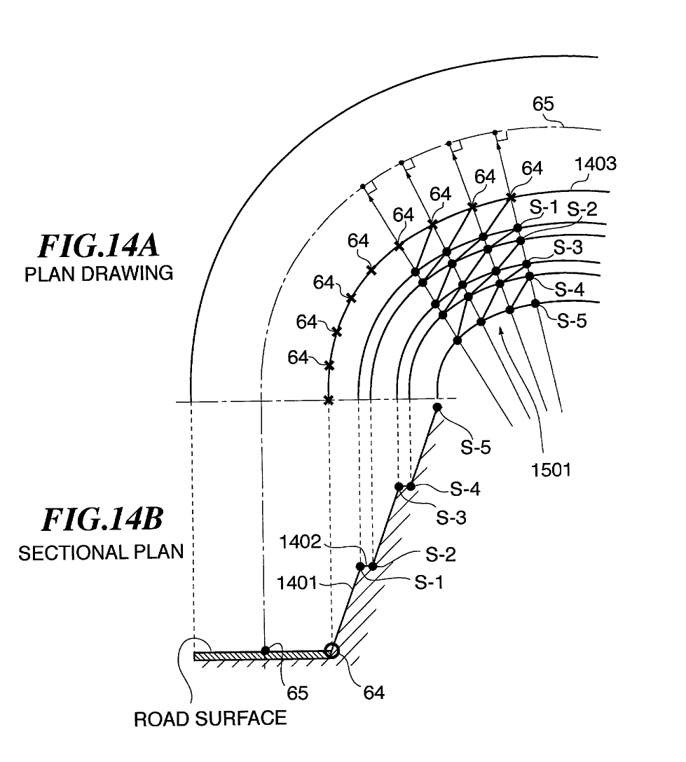

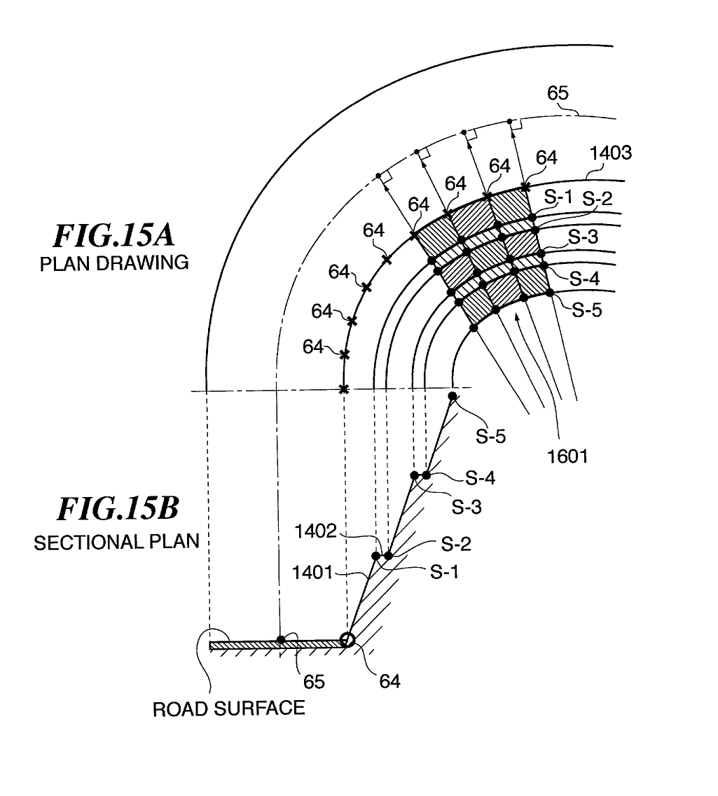

Next, on the basis of each coordinates (x1, y1, z1) to (x5, y5, z5) of each point S1 to S5, a 3D patch (polygon) of a standard crossing is made as shown in FIG. 14A and FIG. 14B. In the same manner, a 3D patch (curve plan) of a standard crossing is made on the basis of each coordinates (x1, y1, z1) to (x5, y5, z5) of each point S1 to S5 as shown in FIG. 15A and FIG. 15B.

By using the 3D patch (curve plane) of a standard crossing made by the above-mentioned processing, (1) a line crossing calculation between land 3D/TIN (polygon) which is divided to contour lines, existent roads, rice fields, outfields, residential regions, etc. and a 3D patch (curve plane) of a standard crossing, or (2) a line crossing calculation between land 3D/TIN (curve plane) which is divided to contour lines, existent roads, rice fields, outfields, residential regions, etc. and a 3D patch (curve plane) of a standard crossing can be executed.

By using this process for calculating cutting and banking planes, the accuracy of mass calculations and/or calculations of a quantity of slope finishing processes is improved significantly, so that labor saving of the drawing work and shortening in drawing man-hour can be attained using automatic calculation processing.

As mentioned above, according to the system and method for designing roads of the present invention, road design can be executed easily by terminals and road design maps and mass calculation documents and/or calculation documents of a quantity of slope finishing processes, etc. can be made easily, because tools with which road design can be made easily by a server linked to a computer network such as the internet are provided.

Although the invention has been described in its preferred form with a certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A system for designing roads, which executes road design by a terminal connected to a computer network, comprising:
a terminal device, which has a function of a client, for inputting information of design conditions and personal information of a user;
a server of designing roads, which has a function of a server, for offering a service for designing roads on the basis of said information of design conditions and said personal information inputted by said terminal device; and
a computer network for linking said terminal device to said server, wherein
said server of designing roads comprises,
network processing means, which is connected to said computer network, for receiving said information of design conditions and said personal information inputted by said terminal device and for receiving and sending information with said terminal device, and
road design processing means for executing road design on the basis of said information of design conditions and said personal information received by said network processing means and for generating road design maps and calculation documents.

2. The system for designing roads of claim 1, wherein
said network processing means transmits said road design maps and said calculation documents generated by said road design processing means to said terminal device.

3. The system for designing roads of claim 2, wherein
said network processing means transmits said road design maps and said calculation documents to said terminal device as Web pages.

4. The system for designing roads of claim 2, wherein
said network processing means transmits said road design maps and said calculation documents to said terminal device as E-mails.

5. The system for designing roads of claim 1, wherein
said terminal device transmits said information of design conditions and said personal information of the user by inputting on Web pages provided by said server of designing roads.

6. The system for designing roads of claim 1, wherein said road design processing means comprises:
road design map generating means for generating said road design maps; and
cutting and banking planes calculating means for calculating a mass of cutting and banking planes and an area of a slope finishing mentioned in said calculation documents.

7. The system for designing roads of claim 6, wherein said road design map generating means of said road design processing means changes a road centerline on an arbitrary point continuously and automatically in accordance with an instruction to input externally.

8. The system for designing roads of claim 6, wherein said road design map generating means of said road design processing means changes a road vertical curve on an arbitrary point continuously and automatically in accordance with an instruction to input externally.

9. The system for designing roads of claim 6, wherein said road design map generating means of said road design processing means changes a figure of an intelli-shape automatically in accordance with an instruction to input externally.

10. The system for designing roads of claim 7, wherein said road design map generating means of said road design processing means shows change ranges of a road centerline, a road vertical curve and a figure of an intelli-shape in accordance with an instruction to input externally.

11. The system for designing roads of claim 6, wherein said cutting and banking planes calculating means of said road design processing means uses a three dimensional patch (curve plane) of a standard crossing.

12. A method for designing roads, which executes road design by using a computer network, comprising the steps of:
(A) transmitting screen images for offering information to a terminal device connected to the computer network;
(B) receiving information of design conditions and personal information of a user inputted on the screen images for offering information by the terminal device;
(C) designing roads on the basis of the information of design conditions and the personal information received in said step (B) and generating road design maps and calculation documents; and
(D) transmitting the road design maps and the calculation documents generated in said step (C) to the terminal device.

13. The method for designing roads of claim 12, wherein
said steps (A) and (D) comprises the step of transmitting the screen images for offering information, the road design maps and the calculation documents to the terminal device as Web pages.

14. The method for designing roads of claim 12, wherein
said step (D) comprises the step of transmitting the road design maps and the calculation documents to the terminal device as E-mails.

15. The method for designing roads of claims 12, said step of (C) comprises the steps of:
(c1) designing roads on the basis of the information of design conditions and the personal information received in said step (B) and generating road design maps;
(c2) calculating a mass of cutting and banking planes and an area of a slope finishing on the basis of the road design maps; and
(c3) generating calculation documents mentioned the mass of cutting and banking planes and the area of a slope finishing.

16. The method for designing roads of claim 15, wherein
said step (c1) comprises the step of changing a road centerline on an arbitrary point continuously and automatically in accordance with an instruction to input externally.

17. The method for designing roads of claim 15, wherein
said step (c1) comprises the step of changing a road vertical curve on an arbitrary point continuously and automatically in accordance with an instruction to input externally.

18. The method for designing roads of claim 15, wherein
said step (c1) comprises the step of changing a figure of an intelli-shape automatically in accordance with an instruction to input externally.

19. The method for designing roads of claim 16, wherein
said step (c1) comprises the step of showing change ranges of a road centerline, a road vertical curve and a figure of an intelli-shape.

20. The method for designing roads of claim 15, wherein
said step (c2) comprises the step of calculating a mass of cutting and banking planes and an area of a slope finishing by using a three dimensional patch (curve plane) of a standard crossing.
